(19) United States
(12) Patent Application Publication
(10) Pub. No.: US 2026/0154302 A1
(43) Pub. Date: Jun. 4, 2026

(54) SYSTEM AND METHOD FOR CYBERSECURITY POLICY GENERATION FOR A COMPUTING ENVIRONMENT

(71) Applicant: Wiz, Inc., New York, NY (US)

(72) Inventors: George PISHA, Giv'atayim (IL); Liran MOYSI, Kfar Saba (IL)

(73) Assignee: Wiz, Inc., New York, NY (US)

(21) Appl. No.: 18/968,619

(22) Filed: Dec. 4, 2024

(51) Int. Cl. G06F 16/3331; G06F 16/3329

(52) U.S. Cl. CPC G06F 16/3331; G06F 16/3329

(57) ABSTRACT

A system and method for generating a cybersecurity policy for a computing environment is presented. The method includes generating a representation of a computing environment in a security database having a predefined data schema; receiving a natural language query; matching the natural language query to a preexisting policy of a policy engine, the policy engine configured to apply a policy on the representation; generating a prompt for a large language model (LLM) based on the natural language query and the preexisting policy; applying a first policy to the representation, the first policy extracted from a result of executing the prompt utilizing the LLM.

### TECHNICAL FIELD

The present disclosure relates generally to the field of cybersecurity, and specifically to policy generation for a computing environment.

### BACKGROUND

Cybersecurity policy generation involves the development of guidelines, regulations, and strategies aimed at protecting digital systems, networks, and data from cyber threats. It encompasses a broad range of considerations, including technical standards, legal frameworks, risk management strategies, and international cooperation efforts.

The evolution of cybersecurity policy has been driven by the proliferation of digital technologies and the increasing interconnectedness of global networks. As cyber threats have become more sophisticated and pervasive, policymakers have recognized the need for comprehensive approaches to address these challenges effectively.

One major challenge in the field of cybersecurity is the need for policies to be adaptable and flexible to keep pace with emerging cyber threats, which often outpace traditional policymaking processes. Additionally, the interconnected nature of modern digital ecosystems presents challenges in crafting polices that effectively address risks across diverse industries and sectors. Another critical concern is the balance between security and privacy, as policies must navigate the delicate balance between protecting sensitive data and preserving individual liberties.

Furthermore, the rise of artificial intelligence and machine learning introduces complexities in both cybersecurity defense strategies and potential policy implications. Moreover, the global nature of cyberspace necessitates international cooperation and coordination, highlighting the need for cybersecurity policies that can effectively transcend geopolitical boundaries.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include generating a representation of a computing environment in a security database having a predefined data schema. The method may also include receiving a natural language query. The method may furthermore include matching the natural language query to a preexisting policy of a policy engine, the policy engine configured to apply a policy on the representation. The method may in addition include generating a prompt for a large language model (LLM) based on the natural language query and the preexisting policy. The method may moreover include applying a first policy to the representation, the first policy extracted from a result of executing the prompt utilizing the LLM. Other embodiments of this aspect include corresponding computer systems, apparatus, and computer programs recorded on one or more computer storage devices, each configured to perform the actions of the methods.

Implementations may include one or more of the following features. The method may include: initiating a remediation action in response to applying the first policy resulting in a fail. The method may include: matching the natural language query to a plurality of preexisting policies, each match associated with a match score. The method may include: generating the prompt based on a group of preexisting policies of the plurality of preexisting policies, each preexisting policy of the group of preexisting policies associated with a match score that exceeds a threshold value. The method may include: generating the prompt further based on a first preexisting policy utilizing a first framework and a second preexisting policy utilizing a second framework. The method may include: generating the prompt based on a predetermined template, the predetermined template configured to produce a result utilizing the first framework. The method where matching the natural language query to the preexisting policy further may include: generating a first vector in a feature space based on the natural language query; generating a second vector in the feature space based on the preexisting policy; and determining a distance in the feature space between the first vector and the second vector. The method may include: determining that the preexisting policy matches the natural language query when the determined distance is below a threshold. The method may include: selecting a schema based on the natural language query; and generating the prompt further based on the selected schema. Implementations of the described techniques may include hardware, a method or process, or a computer tangible medium.

In one general aspect, non-transitory computer-readable medium may include one or more instructions that, when executed by one or more processors of a device, cause the device to: generate a representation of a computing environment in a security database having a predefined data schema; receive a natural language query; match the natural language query to a preexisting policy of a policy engine, the policy engine configured to apply a policy on the representation; generate a prompt for a large language model (LLM) based on the natural language query and the preexisting policy; apply a first policy to the representation, the first policy extracted from a result of executing the prompt utilizing the LLM. Other embodiments of this aspect include corresponding computer systems, apparatus, and computer programs recorded on one or more computer storage devices, each configured to perform the actions of the methods.

In one general aspect, system may include one or more processors configured to: generate a representation of a computing environment in a security database having a predefined data schema. The system may furthermore receive a natural language query. The system may in addition match the natural language query to a preexisting policy of a policy engine, the policy engine configured to apply a policy on the representation. The system may moreover generate a prompt for a large language model (LLM) based on the natural language query and the preexisting policy. The system may also apply a first policy to the representation, the first policy extracted from a result of executing the prompt utilizing the LLM. Other embodiments of this aspect include corresponding computer systems, apparatus, and computer programs recorded on one or more computer storage devices, each configured to perform the actions of the methods.

Implementations may include one or more of the following features. The system where the one or more processors are further configured to: initiate a remediation action in response to applying the first policy resulting in a fail. The system where the one or more processors are further configured to: match the natural language query to a plurality of preexisting policies, each match associated with a match score. The system where the one or more processors are further configured to: generate the prompt based on a group of preexisting policies of the plurality of preexisting policies, each preexisting policy of the group of preexisting policies associated with a match score that exceeds a threshold value. The system where the one or more processors are further configured to: generate the prompt further based on a first preexisting policy utilizing a first framework and a second preexisting policy utilizing a second framework. The system where the one or more processors are further configured to: generate the prompt based on a predetermined template, the predetermined template configured to produce a result utilizing the first framework. The system where the one or more processors, when matching the natural language query to the preexisting policy, are configured to: generate a first vector in a feature space based on the natural language query; generate a second vector in the feature space based on the preexisting policy; and determine a distance in the feature space between the first vector and the second vector. The system where the one or more processors are further configured to: determine that the preexisting policy matches the natural language query when the determined distance is below a threshold. The system where the one or more processors are further configured to: select a schema based on the natural language query; and generate the prompt further based on the selected schema. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a computing environment communicatively coupled with a cybersecurity inspection environment, utilized to describe an embodiment.

FIG. 2 is an example schematic illustration of a natural language query processor, according to an embodiment.

FIG. 3 is an example flowchart of a method for generating a database query based on a natural language query, according to an embodiment.

FIG. 4 is an example flowchart of a method for generating a database query based on a natural language query utilizing a large language model, according to an embodiment.

FIG. 5 is an example schematic diagram of a natural language query processor, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for a natural language cybersecurity policy generation. The disclosed embodiments include methods and systems for a natural language processor configured to generate a representation of a computing environment, receive a natural language query, and match the natural language query to a preexisting policy. Then the natural language query is configured to generate a prompt for large language model (LLM), and apply a first policy to the representation.

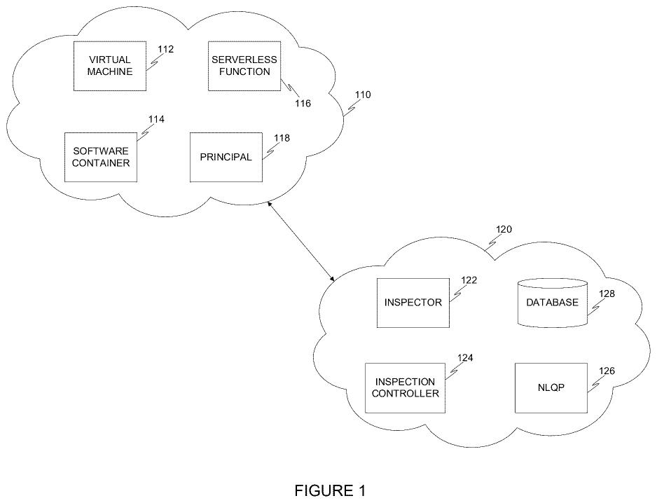

FIG. 1 is an example schematic diagram of a computing environment communicatively coupled with a cybersecurity inspection environment, utilized to describe an embodiment. A computing environment 110 is, according to an embodiment, a cloud computing environment, a networked environment, an on-premises environment, a combination thereof, and the like.

For example, in an embodiment, a cloud computing environment is implemented as a virtual private cloud (VPC), a virtual network (VNet), and the like, on a cloud computing infrastructure. A cloud computing infrastructure is, according to an embodiment, Amazon® Web Services (AWS), Google® Cloud Platform (GCP), Microsoft® Azure, and the like.

In certain embodiments, the computing environment 110 includes a plurality of entities. An entity in a computing environment 110 is, for example, a resource, a principal 118, and the like. A resource is, according to an embodiment, a hardware, a bare metal machine, a virtual machine, a virtual workload, a provisioned hardware (or portion thereof, such as a processor, a memory, a storage, etc.), and the like.

A principal 118 is an entity which is authorized to perform an action on a resource, initiate an action in the computing environment 110, initiate actions with respect to other principals, a combination thereof, and the like. According to an embodiment, a principal is a user account, a service account, a role, a combination thereof, and the like.

In certain embodiments, a resource in a computing environment is a virtual machine 112, a software container 114, a serverless function 116, and the like. For example, in an embodiment, a virtual machine 112 is implemented as an Oracle® VirtualBox®. In some embodiments, a software container 114 is implemented utilizing a Docker® Engine, a Kubernetes® platform, combinations thereof, and the like. In certain embodiments, a serverless function 116 is implemented in AWS utilizing Amazon Lambda®.

In some embodiments, the computing environment 110 is implemented as a cloud environment which includes multiple computing environments. For example, a first cloud computing environment is utilized as a production environment, a second cloud computing environment is utilized as a staging environment, a third cloud computing environment is utilized as a development environment, and so on. Each such environment includes, according to an embodiment, a resource, a principal, and the like, having a counterpart in the other environments.

For example, according to an embodiment, a first virtual machine 112 is deployed in a production environment, and a corresponding first virtual machine is deployed in a staging environment, which is essentially identical to the production environment.

In an embodiment, the computing environment 110 is monitored by an inspection environment 120. According to an embodiment, the inspection environment 120 is configured to inspect, scan, detect, and the like, cybersecurity threats, cybersecurity risks, cybersecurity objects, misconfigurations, vulnerabilities, exploitations, malware, combinations thereof, and the like.

In certain embodiments, the inspection environment 120 is further configured to provide a mitigation action, a remediation action, a forensic finding, a combination thereof, and the like.

In some embodiments, an inspector 122 is configured to detect a cybersecurity object in a workload deployed in the computing environment 110. For example, in an embodiment, the inspector is a software container pod configured to detect a predetermined cybersecurity object in a disk, access to which is provided to the inspector 122 by, for example, the inspection controller 124.

In an embodiment, a cybersecurity object is a password stored in cleartext, a password stored in plaintext, a hash, a certificate, a cryptographic key, a private key, a public key, a hash of a file, a signature of a file, a malware object, a code object, an application, an operating system, a combination thereof, and the like.

In certain embodiments, the inspector 122 is assigned to inspect a workload in the computing environment 110 by an inspection controller 124. In an embodiment, the inspection controller initiates inspection by, for example, generating an inspectable disk based on an original disk. In an embodiment, generating the inspectable disk include generating a copy, a clone, a snapshot, a combination thereof, and the like, of a disk of a workload deployed in the computing environment 110, and providing access to the inspectable disk (for example by assigning a persistent volume claim) to an inspector 122.

In an embodiment, where an inspector 122 detects a cybersecurity object in a disk of a workload, a representation is generated and stored in a security database 128. In certain embodiments, the database is a columnar database, a graph database, a structured database, an unstructured database, a combination thereof, and the like. In certain embodiments, the representation is generated based on a predefined data schema. For example, a first data schema is utilized to generate a representation of a resource, a second data schema is utilized to generate a representation of a principal, a third data schema is utilized to generated a representation of a cybersecurity object, etc.

For example, according to an embodiment, the representation is stored on a graph database, such as Neo4j®. In certain embodiments, a resource is represented by a resource node in the security graph, a principal is represented by a principal node in the security graph, etc.

In some embodiments, the inspection environment 120 further includes a natural language query processor 126 (NLQP 126). In an embodiment, the NLQP 126 is configured to receive a query in a natural language, and generate, based on the received query, a structured query which is executable on the database 128.

In certain embodiments, it is advantageous to provide a user with an interface to query the database 128 in a natural language. It is further advantageous to provide a system and method that provides accurate translation between a query received in natural language and a database query, in order to provide a user with a relevant result to their query.

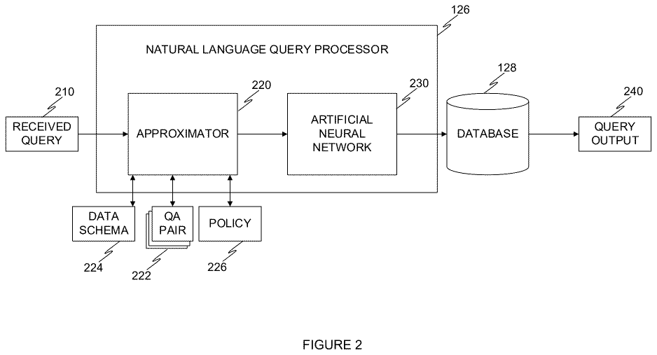

FIG. 2 is an example schematic illustration of a natural language query processor, implemented in accordance with an embodiment. In certain embodiments, the natural language query processor 126 (NLQP 126) is implemented as a virtual workload in an inspection environment. In some embodiments, the NLQP 126 includes an approximator 220, and an artificial neural network (ANN) 230. In some embodiments, the ANN 230 is a large language model, such as GPT, BERT, and the like.

In an embodiment, the NLQP 126 receives a query 210. In some embodiments, the received query 210 is a query in natural language, such as an English language query. In an embodiment, the received query 210 cannot be executed on a database, such as security database 128. In certain embodiments, the security database 128 includes a representation of a computing environment, such as the computing environment 110 of FIG. 1 above.

In an embodiment, the received query 210 is provided to the approximator 220. In an embodiment, the approximator 220 includes a large language model (LLM), such as GPT, BERT, and the like. While an LLM is discussed here, other embodiments can utilize various generative artificial intelligence (AI) models, such as language models (e.g., small language models, large language models), generative adversarial networks (GANs), combinations thereof, and the like.

In some embodiments, the LLM (e.g., of the approximator 220, the ANN 230, etc.) includes a fine-tuning mechanism. In an embodiment, fine-tuning allows to freeze some weights of a neural network while adapting others based on training data which is unique to a particular set of data.

In certain embodiments, an LLM cannot be fine-tuned, for example due to a lack of access to weights of the model. In such embodiments, it is advantageous to provide the LLM with additional data in order to generate a result which is accurate and relevant.

For example, in an embodiment, the approximator 220 is provided with a plurality of query-answer (QA) pairs 222, and a data schema 224. In an embodiment, the QA pairs 222 include each a database query and a corresponding response. In some embodiments, the query of the QA pair 222 is a query which was previously executed on the database 128.

In some embodiments, the data schema 224 is a data schema of the database 128. In some embodiments, a plurality of data schemas 224 are utilized. For example, in an embodiment, the plurality of data schemas 224 include a data schema for a principal, a data schema for a resource, a data schema of a cloud computing environment, combinations thereof, and the like.

In an embodiment, the approximator 220 is configured to generate a prompt based on a predetermined template, the received query 210, a QA pair 222, and the data schema 224. In some embodiments, the approximator is configured to receive the query 210 and generate a selection of a QA pair 222 from a plurality of QA pairs. For example, in an embodiment, the approximator is configured to receive the query 210, and generate a prompt for an LLM to detect from a plurality of QA pairs, a QA pair 222 which is the closest match to the received query 222. In some embodiments, the prompt further includes the data schema 224.

In an embodiment, the output of the approximator 220 is a QA pair 222 which an LLM of the approximator 220 outputs as being the closest match to the received query 210. In some embodiments, the approximator 220 outputs a group of QA pairs from the plurality of QA pairs.

In certain embodiments, the output of the approximator 220 is provided to the ANN 230. In an embodiment, the ANN 230 is configured to generate a database query (i.e., a query which is executable by a database, database management system, etc.) based on the output of the approximator 220. In some embodiments, the ANN 230 includes an LLM, and is configured to generate a prompt for the LLM based on the received output, the received query 210, and the data schema 224.

For example, in an embodiment, the ANN 230 is configured to receive the query 210, a QA pair 222 selected by the approximator 220, and the data schema 224 as inputs. The ANN 230 is further configured to generate a prompt for an LLM based on the received inputs, which, according to an embodiment, configures the LLM to output a database query based on the received inputs.

In an embodiment, the outputted database query is executed on a database 128 to provide a query output 240. In an embodiment, a plurality of database queries are outputted by the NLQP 216, each of which is executed on a database, such as database 128. In such embodiments, a plurality of query outputs 240 are generated.

In some embodiments, the query output 240 is provided to a client device, a user account, a user interface, rendered for display on a graphical user interface, a combination thereof, and the like.

According to an embodiment, the approximator 220 is configured to receive a policy 226, a plurality of policies, and the like, which are utilized in generating a policy by the ANN 230. For example, in an embodiment, the received query 210 is a natural language statement which is directed at generating a cybersecurity policy. In an embodiment, the approximator 220 is configured to receive an existing policy 226, a plurality of existing policies, and the like, and generate a new policy based on the received query 210 and the policy 226.

In some embodiments, the ANN 230 is configured to generated a prompt for an LLM which when executed utilizing the LLM outputs a policy which is enforced, for example, on a representation of a computing environment, such as stored in the security database 128 of FIG. 1 above.

In an embodiment, a first policy is provided to the approximator 220 utilizes a first language format, while a second policy is provided to the approximator 220 which utilizes a second language format (e.g., Rego). According to some embodiments, the ANN 230 is further configured to generate a policy for a specific format, framework, and the like, and is configured to utilize policies of different frameworks.

In certain embodiments, the NLQP 126 is further configured to simulate an application of a policy. For example, in an embodiment, it is advantageous to simulate an application of a policy which was generated by a large language model, as these LLMs are prone to generating responses known colloquially as ‘hallucinations’.

In this regard, a hallucination is a response, result, and the like, of executing a prompt, which while appearing to be correct, does not in practice result in the intended manner. In the context of cybersecurity policies, a hallucination is, according to an embodiment, a result which appears to be a correct policy, but when applied produces results which were not intended. For example, according to an embodiment, applying a policy which aims to detect S3 buckets without encryption, and receiving an identifier of an S3 bucket which includes encryption, would be a policy which does not perform as intended.

In certain embodiments, a policy is associated with an action, such as a remediation action, a mitigation action, a combination thereof, and the like. In some embodiments, a simulating a policy application on a representation of a computing environment includes generating a list of entities which fail the policy, without executing any action which is associated with the policy.

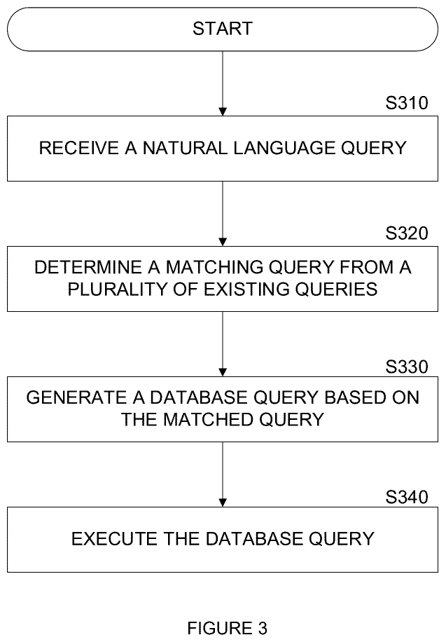

FIG. 3 is an example flowchart of a method for generating a database query based on a natural language query, implemented in accordance with an embodiment. In an embodiment, the method is performed by utilizing an artificial neural network.

At S310, a natural language query is received. In an embodiment, the natural language query is received through a user interface, a graphical user interface, and the like. In some embodiments, a natural language query is an unstructured query, a partially structured query, and the like. For example, a structured query is a query which can be executed on a database to produce a result, whereas an unstructured query, a partially structured query, and the like, cannot be executed on a database to produce a result, according to an embodiment.

For example, according to an embodiment, a natural language query is “public ECRs with container images that contain cloud keys”, “find all vulnerabilities that can be exploited remotely”, “find all vulnerabilities that lead to information disclosure”.

In some embodiments, the natural language query is processed for tokenization. In an embodiment, each word in the natural language query is mapped to a tokenized word, tokenized word portion, and the like. For example, in an embodiment, vulnerability, vulnerabilities, vulnerabilites (with an incorrect spelling) are all mapped to a single term (e.g., “vulnerable”), and the single term is tokenized. This is advantageous as the context is preserved while tokenization is minimized, since only a single term is tokenized, rather than having to tokenize each different term.

At S320, an existing query is selected. In an embodiment, the existing query is an existing database query. In some embodiments, the selection includes a query pair, including a database query and a response, result, and the like, which is generated based on execution of the database query on a database.

In an embodiment, the existing query is selected from a group of preselected queries. In some embodiments, a match is determined between the natural language query and a plurality of existing queries. In certain embodiments, generating a match includes determining a match score. For example, in an embodiment, a match score is generated between a natural language query and a preexisting database query based on natural language processing (NLP) techniques, such as the distance-based Word2Vec.

For example, in an embodiment, a distance is determined between the received natural language query and a first preexisting database query, and between the received natural language query and a second preexisting database query. In certain embodiments, the preexisting query having a shorter distance to the natural language query is selected as the matched query.

At S330, a database query is generated. In an embodiment, the database query is generated based on the received natural language query and the selected existing query. In certain embodiments, the database query is generated by adapting the existing query to the received natural language query. In an embodiment, adapting the existing query based on the received natural language query is performed by an artificial neural network, such as a generative ANN. In some embodiments, the adaptation is performed by a generative adversarial network (GAN), which includes a generator network and a discriminator network.

At S340, the database query is executed. In an embodiment, executing a database query includes configuring a database management system to receive a database query, execute the database query on one or more datasets stored in the database, and generate a result.

In certain embodiments, where a plurality of database queries are generated, each query is executed on a database. According to an embodiment, each query is executed on the same database, a different database, a combination thereof, and the like.

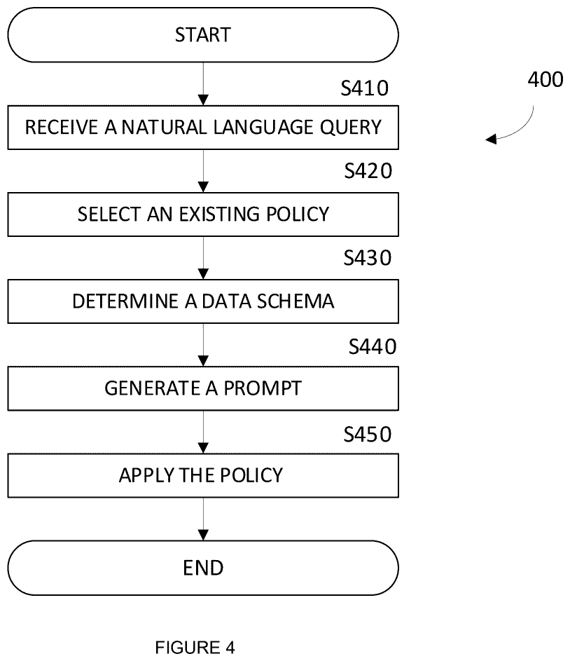

FIG. 4 is an example flowchart 400 of a method for generating a cybersecurity policy based on a natural language query utilizing a large language model, implemented in accordance with an embodiment. In an embodiment, the method is performed by utilizing an artificial neural network such as an LLM. For example, an LLM is, according to an embodiment, GPT, BERT, and the like.

In certain embodiments, a policy is generated based on a predefined schema, for example, in an embodiment, a policy is generated in a schema associated with Rego language, which is utilized by an OPA engine to apply a policy.

At S410, a natural language query is received. In an embodiment, the natural language query is received through a user interface, a graphical user interface, and the like. In some embodiments, a natural language query is an unstructured query, a partially structured query, and the like. For example, a structured query is a query which can be executed on a database to produce a result, whereas an unstructured query, a partially structured query, and the like, cannot be executed on a database to produce a result, according to an embodiment.

For example, according to an embodiment, a natural language query is “S3 bucket with encryption disabled”, “vulnerabilities that can be exploited remotely”, “vulnerabilities that lead to information disclosure”, etc.

In some embodiments, the natural language query is processed for tokenization. In an embodiment, each word in the natural language query is mapped to a tokenized word, tokenized word portion, and the like. For example, in an embodiment, vulnerability, vulnerabilities, vulnerabilites (with an incorrect spelling) are all mapped to a single term (e.g., “vulnerable”), and the single term is tokenized. This is advantageous as the context is preserved while tokenization is minimized, since only a single term is tokenized, rather than having to tokenize each different term.

At S420, an existing policy is selected. In an embodiment, the existing policy is selected from a group including policies encoded in multiple types of different languages, different codes, different schemas, a combination thereof, and the like.

In some embodiments, a plurality of existing policies are selected. In certain embodiments, an existing policy is matched to the received query. For example, in an embodiment, an existing policy is vectorized to produce a first vector in a feature space, for example utilizing Word2Vec, and the query is vectorized to produce a second vector in the feature space.

In an embodiment, a distance is determined between the first vector and the second vector, and an existing policy is determined to be a match to the query where the determined distance is at a threshold, below a threshold, etc.

In certain embodiments, a prompt is generated for an LLM to determine if an existing policy matches a received natural language query. In an embodiment, where an output of executing the prompt utilizing the LLM indicates that the policy matches, another prompt is generated to determine if another existing policy matches the natural language query. In certain embodiments, a match score is determined for the match, for example based on a vector distance in a feature space.

At optional S430, a data schema is determined. In certain embodiments a plurality of data schemas are determined. In an embodiment, the data schema is determined based on the natural language query. For example, in an embodiment, a keyword, a phrase, and the like, are detected in the natural language query.

In some embodiments, the natural language query is received as a text input which is parsed, and a keyword is detected in the parsed text. In an embodiment, the keyword, phrase, and the like, is matched to a data schema. For example, in the natural language query “S3 bucket with encryption disabled”, the keyword “bucket” corresponds to a data schema of a resource.

At S440, a prompt is generated. In an embodiment, the prompt is generated for a large language model. In some embodiments, the prompt is generated based on a predefined template. In certain embodiments, the prompt includes the natural language query, a selected existing policy, a data schema, a combination thereof, and the like.

In an embodiment, the prompt, when executed utilizing an LLM, generates an output which includes a policy. In some embodiments, the output includes a policy generated in a specific schema, language, code, etc., such as Rego. In an embodiment, the prompt further utilizes a retrieval augmented generation (RAG) technique. In such an embodiment, a data schema is utilized for the RAG.

At S450, the policy is applied. In an embodiment, the policy is extracted from an output of an LLM. In some embodiments, the policy is applied by providing the policy to an engine, such as the OPA engine.

According to an embodiment, a policy is applied on a representation of a computing environment. For example, according to an embodiment, a policy is applied on a representation of a computing environment, such as the representation of the computing environment which is stored in the security database 128 of FIG. 1 above.

In some embodiments, applying a policy includes performing a check to determine if the policy is a valid policy. For example, in an embodiment, a hallucination detection technique is applied to the policy to determine if the generated policy, when applied, corresponds to an intent of a user which provided the natural language query.

In an embodiment, a validity check includes simulating applying the policy on a representation of the computing environment, receiving a result of applying the policy, and determining if the result is an expected result. For example, in an embodiment, where the natural language query is “S3 bucket with encryption disabled”, a policy is generated which when applied to a representation of the computing environment flags an S3 bucket with encryption enabled, then the policy is an invalid policy (i.e., not a valid policy).

In certain embodiments, where a policy fails a validity check, the steps of the method are repeated to generate a new policy. In some embodiments, the policy which failed the validity check is provided to the LLM (e.g., through a prompt, utilizing RAG, etc.) in order to provide an example of a failed policy. According to an embodiment, this reduces the probability that the LLM will again produce the same policy, a variation thereof, and the like, which has previously failed.

In some embodiments, a policy further includes a remediation action, a mitigation action, a combination thereof, and the like. For example, in an embodiment, an action includes generating an alert, generating an alert severity, updating an alert severity, generating a ticket, sandboxing a resource, disabling a principal, a combination thereof, and the like.

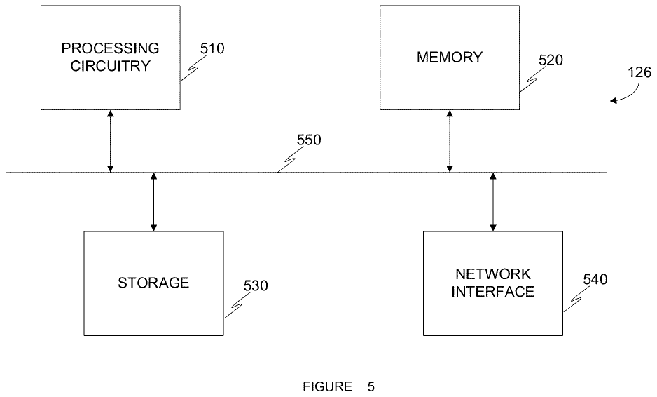

FIG. 5 is an example schematic diagram of a natural language query processor 126 according to an embodiment. The natural language query processor 126 includes a processing circuitry 510 coupled to a memory 520, a storage 530, and a network interface 540. In an embodiment, the components of the natural language query processor 126 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof. In an embodiment, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein may be stored in the storage 530, in the memory 520, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 540 is configured to provide the natural language query processor 126 with communication with, for example, the security database 128.

It should be understood that the embodiments described herein are not limited to the specific architecture illustrated in FIG. 5, and other architectures may be equally used without departing from the scope of the disclosed embodiments.

Furthermore, in certain embodiments the inspector 122, the inspection controller 124, the security database 128, and the like may be implemented with the architecture illustrated in FIG. 5. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for generating a cybersecurity policy for a computing environment, comprising:
generating a representation of a computing environment in a security database having a predefined data schema;
receiving a natural language query;
matching the natural language query to a preexisting policy of a policy engine, the policy engine configured to apply a policy on the representation;
selecting a first data schema based on the natural language query;
generating a prompt for a large language model (LLM) based on the natural language query, the first data schema and the preexisting policy;
executing the prompt utilizing the LLM to generate a first policy;
applying the first policy to the representation; and
determining a result based on the applied first policy.

2. The method of claim 1, further comprising:
initiating a remediation action in the computing environment based on the determined result included at least one fail.

3. The method of claim 1, further comprising:
matching the natural language query to a plurality of preexisting policies, each match associated with a match score; and
generating the prompt based on a group of preexisting policies of the plurality of preexisting policies, each preexisting policy of the group of preexisting policies associated with a match score that exceeds a threshold value.

4. (canceled)

5. The method of claim 3, further comprising:
generating the prompt further based on a first preexisting policy utilizing a first language format and a second preexisting policy utilizing a second language format.

6. The method of claim 5, further comprising:
generating the prompt based on a predetermined template, the predetermined template configured to produce a result utilizing the first language format.

7. The method of claim 1, wherein matching the natural language query to the preexisting policy further comprises:
generating a first vector in a feature space based on the natural language query;
generating a second vector in the feature space based on the preexisting policy; and
determining a distance in the feature space between the first vector and the second vector.

8. The method of claim 7, further comprising:
determining that the preexisting policy matches the natural language query when the determined distance is below a threshold.

9. (canceled)

10. A non-transitory computer-readable medium storing a set of instructions for generating a cybersecurity policy for a computing environment, the set of instructions comprising:
one or more instructions that, when executed by one or more processing circuitries of a device, cause the device to:
generate a representation of a computing environment in a security database having a predefined data schema;
receive a natural language query;
match the natural language query to a preexisting policy of a policy engine, the policy engine configured to apply a policy on the representation;
select a first data schema based on the natural language query;
generate a prompt for a large language model (LLM) based on the natural language query, the first data schema and the preexisting policy;
execute the prompt utilizing the LLM to generate a first policy;
apply the first policy to the representation; and
determine a result based on the applied first policy.

11. A system for generating a cybersecurity policy for a computing environment comprising:
one or more processing circuitries configured to:
generate a representation of a computing environment in a security database having a predefined data schema;
receive a natural language query;
match the natural language query to a preexisting policy of a policy engine, the policy engine configured to apply a policy on the representation;
select a first data schema based on the natural language query;
generate a prompt for a large language model (LLM) based on the natural language query, the first data schema and the preexisting policy;
execute the prompt utilizing the LLM to generate a first policy;
apply the first policy to the representation; and
determine a result based on the applied first policy.

12. The system of claim 11, wherein the one or more processing circuitries are further configured to:
initiate a remediation action in the computing environment based on the determined result included at least one fail.

13. The system of claim 11, wherein the one or more processing circuitries are further configured to:
match the natural language query to a plurality of preexisting policies, each match associated with a match score; and
generate the prompt based on a group of preexisting policies of the plurality of preexisting policies, each preexisting policy of the group of preexisting policies associated with a match score that exceeds a threshold value.

14. (canceled)

15. The system of claim 13, wherein the one or more processing circuitries are further configured to:
generate the prompt further based on a first preexisting policy utilizing a first language format and a second preexisting policy utilizing a second language format.

16. The system of claim 15, wherein the one or more processing circuitries are further configured to:
generate the prompt based on a predetermined template, the predetermined template configured to produce a result utilizing the first language format.

17. The system of claim 11, wherein the one or more processing circuitries, when matching the natural language query to the preexisting policy, are configured to:
generate a first vector in a feature space based on the natural language query;
generate a second vector in the feature space based on the preexisting policy; and
determine a distance in the feature space between the first vector and the second vector.

18. The system of claim 17, wherein the one or more processing circuitries are further configured to:
determine that the preexisting policy matches the natural language query when the determined distance is below a threshold.

19. (canceled)

20. The method of claim 2, further comprising:
simulating the applied first policy based on the determined result did not include at least one fail; and
deploying the applied first policy to the computing environment based on the simulation of the applied first policy.

21. The method of claim 1, further comprising:
identifying a second data schema based on one or more resources in the computing environment;
identifying a third data schema based on one or more principals in the computing environment; and
determining a plurality of data schemas based on at least two of: the first data schema, the second data schema and the third data schema.

22. The method of claim 1, further comprising:
determining a query-answer pair based on the natural language query.

23. The system of claim 12, further comprising:
simulate the applied first policy based on the determined result did not include at least one fail; and
deploy the applied first policy to the computing environment based on the simulation of the applied first policy.

24. The system of claim 11, further comprising:
identify a second data schema based on one or more resources in the computing environment;
identify third data schema based on one or more principals in the computing environment; and
determine a plurality of data schemas based on at least two of: the first data schema, the second data schema and the third data schema.
